(19) United States
(12) Patent Application Publication
(10) Pub. No.: US 2006/0077138 A1
(43) Pub. Date: Apr. 13, 2006

(54) Organic light emitting display and driving method thereof

(76) Inventor: Hong Kwon Kim, Euiwang (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/227,973

(22) Filed: Sep. 14, 2005

(30) Foreign Application Priority Data
Sep. 15, 2004 (KR) 10-2004-73661
Sep. 15, 2004 (KR) 10-2004-73662

(51) Int. Cl. G09G 3/30

(52) U.S. Cl. 345/76

(57) ABSTRACT

An organic light emitting display and a driving method thereof are disclosed which minimize non-uniform brightness due to the different properties of transistors due to their manufacture. The organic light emitting display comprises a plurality of pixels defined by a plurality of scan lines for supplying a scan signal, a plurality of data lines for supplying a data signal, and a plurality of power source lines. Each pixel comprises a pixel circuit for outputting current from the power source line corresponding to the data signal, wherein power is supplied to the power source line corresponding to a sub-frame. Each pixel further comprises an organic light emitting diode configured to emit light depending on the current outputted from the pixel circuit. With this configuration, desired gradation is represented by supplying the first power, having different voltage levels according to the digital data signals of the respective sub-frames, to an anode electrode of the organic light emitting diode. Thus, non-uniformity of brightness due to property difference between transistors in the pixel circuits is minimized.

### CROSS-REFERENCE TO RELATED APPLICATIONS

This application claims the benefit of Korean Patent Application Nos. 10-2004-73661 and 10-2004-73662, filed on Sep. 15, 2004, in the Korean Intellectual Property Office, the disclosure of which is incorporated herein by reference.

### BACKGROUND

1. Field of the Invention

The present invention relates to an organic light emitting display and a driving method thereof, and more particularly, to an organic light emitting display and a driving method thereof, which minimizes non-uniform brightness due to property difference between transistors.

2. Discussion of Related Technology

Various flat panel displays have been developed to replace cathode ray tube (CRT) displays because CRT displays are relatively heavy and bulky. Types of flat panel displays include a liquid crystal display (LCD), a field emission display (FED), a plasma display panel (PDP), and an organic light emitting display (LED).

The organic light emitting display can emit light independently using recombination of an electron and a hole, and is classified into an inorganic-organic light emitting display comprising an inorganic emission layer, and an organic-organic light emitting display comprising an organic emission layer. The organic-organic light emitting display can be referred to as an electroluminescent display.

Unlike passive type displays which require a separate light source, such as an LCD, the organic light emitting display has an advantageously fast response time like a cathode ray tube (CRT) display and emits light independent of a separate light source.

FIG. 1 is a circuit diagram of a pixel 11 provided in an exemplary organic light emitting display. Referring to FIG. 1, an organic light emitting display comprises a plurality of pixels 11 placed in an intersection region of a scan line Sn and a data line Dm. Each individual pixel 11 is selected when a scan signal is applied to a scan line Sn, and emits light corresponding to a data signal applied to the data line Dm.

Each pixel 11 comprises a first power source line VDD, a second power source line VSS, an organic light emitting diode (OLED), and a pixel circuit 40. The OLED comprises an anode electrode connected to the pixel circuit 40, and a cathode electrode connected to the second power source line VSS.

The OLED comprises an emitting layer, an electron transport layer, and a hole transport layer, which are interposed between an anode electrode and a cathode electrode. Additionally, the OLED may comprise an electron injection layer, and a hole injection layer. In the presently described OLED, when voltage is applied between the anode electrode and the cathode electrode, electrons generated from the cathode electrode move to the emitting layer via the electron injection layer and the electron transport layer, and holes generated from the anode electrode move to the emitting layer via the hole injection layer and the hole transport layer. The electrons from the electron transport layer and the holes from the hole transport layer are recombined in the emitting layer, thereby emitting the light.

The pixel circuit 40 comprises a first transistor M1, a second transistor M2, and a capacitor C. The first and second transistors M1 and M2 are p-type metal oxide semiconductor field effect transistors (PMOS FETs). The second power source line VSS has a voltage level lower than that of the first power source line VDD, wherein the second power source line VSS may be at ground level.

The first transistor M1 comprises a gate electrode connected to the scan line Sn, a source electrode connected to the data line Dm, and a drain electrode connected to a first node N1. In operation, the first transistor M1 supplies the data signal from the data line Dm to the first node N1 in response to the scan signal transmitted through the scan line Sn.

The capacitor C stores voltage corresponding to the data signal transmitted to the first node N1 through the first transistor M1 when the scan signal is supplied to the scan line Sn, and then maintains the second transistor M2 to be turned on for one frame when the first transistor M1 is turned off. In an exemplary display device, one second of video data is divided into 60 frames, and a predetermined image is displayed each frame such that a moving or still picture is displayed.

The second transistor M2 comprises a gate electrode connected to the first node N1, wherein the drain electrode of the first transistor M1 and the capacitor C are also commonly connected to the first node N1. The second transistor M2 further comprises a source electrode connected to the first power source line VDD, and a drain electrode connected to the anode electrode of the OLED. The second transistor M2 is configured to adjust the intensity of current provided to the OLED on the basis of the data signal supplied from the first power source line VDD. Thereby, the OLED emits light based on the current supplied from the first power source line VDD through the second transistor M2.

The pixel 11 operates as follows. First, when a low state scan signal is transmitted to the scan line Sn, the first transistor M1 is turned on. Then, the data signal is supplied from the data line Dm to the gate electrode of the second transistor M2 via the first transistor M1 and the first node N1. The capacitor C stores voltage corresponding to a voltage difference between the gate electrode of the second transistor M2 and the first power source line VDD.

The second transistor M2 is then turned on by the voltage applied to the first node N1, and supplies a current corresponding to the data signal to the OLED. Thereby, the OLED emits light based on the current supplied from the second transistor M2, thus displaying an image.

When a high state scan signal is transmitted to the scan line Sn, the second transistor M2 is maintained to be turned on by the voltage stored in the capacitor C, wherein the stored voltage corresponds to the data signal. When the first transistor M1 is turned off, the OLED emits light for one frame, thereby displaying an image. A disadvantage of the pixel circuit 40, however, is that images lack uniform brightness due to a difference between threshold voltages of the second transistors M2 employed in different pixels 11. Where the plurality of pixels 11 are arranged in a pixel portion of a display, the threshold voltages of the second transistors M2 in the plurality of pixels 11 should be identical to one another to display images with uniform brightness. However, due to processing errors during fabrication, the threshold voltages of the second transistors M2 vary. As a result, the pixel portion cannot display images of uniform brightness.

Organic light emitting displays known in the art may additionally comprise a compensation circuit to compensate for non-uniformity between the threshold voltages of the second transistors M2 of the pixel circuit, wherein the non-uniformity is due to a manufacturing process. However, the correction provided by the compensation circuit is limited and does not provide for display of a uniform image.

### SUMMARY OF CERTAIN INVENTIVE EMBODIMENTS

Accordingly, aspects of the invention include an organic light emitting display and a driving method thereof, which minimizes non-uniformity due to manufacturing differences between transistors.

One embodiment of an organic light emitting display comprises a plurality of pixels defined by a plurality of scan lines configured to supply a scan signal, a plurality of data lines configured to supply a data signal, and a plurality of power source lines. Each pixel comprises a pixel circuit configured to output current from the power source line and corresponding to the data signal, wherein the current output from the pixel circuit corresponds to a sub-frame. The display further comprises an organic light emitting diode configured to emit light in response to the current output from the pixel circuit.

In certain embodiments, each pixel represents gradation (or gray scale) on the basis of a brightness sum of light emitted from the organic light emitting diode in each sub-frame. The data signal includes a digital data signal having i bits corresponding to each sub-frame, where i is a positive integer. In some embodiments, a voltage level of the power supply increases as the bit position of the digital data signal approaches a most significant bit.

Another embodiment of an organic light emitting display comprises a pixel portion comprising a plurality of pixels that are defined by a plurality of scan lines, a plurality of data lines, and a plurality of first power source lines. The pixels are configured to emit light in response to a current corresponding to a data signal transmitted through the data line from the first power source line. The display further comprises a data driver configured to supply the data signal to the data line, a scan driver configured to supply the scan signal to the scan line, and a first power supply configured to supply the first power to the first power source line in correspondence to a sub-frame of one frame.

Another aspect of the invention comprises a method of driving an organic light emitting display comprising a plurality of pixels defined by a plurality of scan lines, a plurality of data lines, and a plurality of power source lines. The method comprises supplying a scan signal to the scan line, supplying a data signal to the data line, supplying power to the power source line corresponding to a sub-frame of one frame, and supplying current, corresponding to the data signal, from the power source line to the pixel such that each pixel emits light.

Yet another embodiment of an organic light emitting display comprises a plurality of pixels defined by a plurality of scan lines through which a scan signal is supplied, a plurality of data lines through which a data signal is supplied, and a plurality of power source lines. Each pixel comprises a pixel circuit comprising a transistor configured to output current corresponding to the data signal from the power source line, wherein the power source line is configured to supply power corresponding to a sub-frame of one frame. The pixel circuit further comprises a compensation circuit configured to compensate a threshold voltage of the transistor. The display further comprises an organic light emitting diode configured to emit light in response to the current output from the pixel circuit.

In some embodiments, the organic light emitting display further comprises an emission control line configured to supply an emission control signal, and an initialization power source line configured to supply initialization power.

According to an embodiment of the invention, each pixel represents gradation on the basis of a brightness sum of light emitted from the organic light emitting diode in each sub-frame. In some embodiments, the data signal includes a digital data signal having i bits corresponding to each sub-frame, where i is a positive integer. In certain embodiments, a voltage level of the power increases as the bit position of the digital data signal approaches a most significant bit.

Another embodiment of an organic light emitting display comprises a pixel portion comprising a plurality of pixels that are defined by a plurality of scan lines, a plurality of data lines, and a plurality of power source lines. Each pixel is configured to emit light in response to a current received from the power source line and corresponding to a data signal transmitted through the data line. The display further comprises a data driver configured to supply the data signal to the data line, a scan driver configured to supply the scan signal to the scan line, a power supply configured to supply power to the first power source line in correspondence to a sub-frame of one frame, and an initialization power supply configured to supply initialization power to each pixel.

In certain embodiments, each pixel represents gradation on the basis of a brightness sum of light emitted from the organic light emitting diode in each sub-frame. In some embodiments, the data signal includes a digital data signal having i bits corresponding to each sub-frame, where i is a positive integer. A voltage level of the power may increase as the bit position of the digital data signal gets closer to a most significant bit.

An additional aspect of the invention includes a method of driving a plurality of pixels defined by a plurality of scan lines, a plurality of data lines, and a plurality of power source lines, wherein each pixel comprises a transistor to output current corresponding to a data signal supplied through one of the data lines. The method comprises charging a capacitor with voltage corresponding to a threshold voltage of the transistor on the basis of initialization power, wherein the capacitor is charged in correspondence to a first scan signal transmitted through a first scan line. The method further comprises supplying the data signal to the data line, supplying power to the power source line in correspondence to a sub-frame of one frame, charging the capacitor with a voltage corresponding to a difference between the data signal and the supplied power, wherein the capacitor is charged in correspondence to a second scan signal supplied through a second scan line. The method further comprises powering an organic light emitting diode to emit light by driving the transistor using the voltage stored in the capacitor, and by outputting the current from the power source line.

### BRIEF DESCRIPTION OF THE DRAWINGS

Aspects and advantages of the invention will become apparent and more readily appreciated from the following description, taken in conjunction with the accompanying drawings.

FIG. 1 is a circuit diagram of a pixel in an exemplary organic light emitting display;

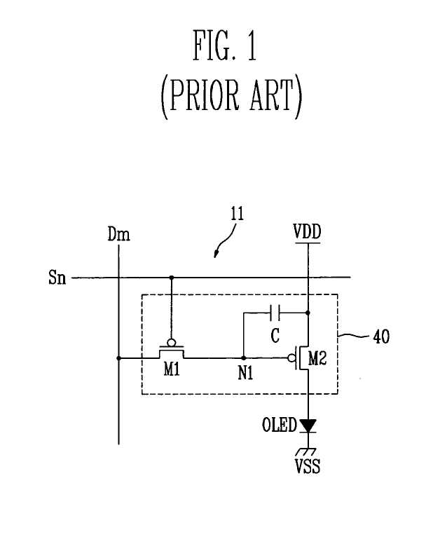

FIG. 2 is an illustration of an organic light emitting display according to a first embodiment of the invention;

FIG. 3 is a block diagram of one embodiment of a first power supply employed in the organic light emitting display of FIG. 2;

FIG. 4 is a circuit diagram of one embodiment of the pixel of the organic light emitting display of FIG. 2;

FIG. 5 is an illustration of signal waveforms for driving the organic light emitting display of FIG. 2;

FIG. 6 is a circuit diagram of a second embodiment of a pixel of a second embodiment of an organic light emitting display;

FIG. 7 is an illustration of signal waveforms for driving the organic light emitting display employing the pixel of FIG. 6;

FIG. 8 is an illustration of a third embodiment of an organic light emitting display;

FIG. 9 is a circuit diagram of a pixel provided in the organic light emitting display of FIG. 8;

FIG. 10 is an illustration of signal waveforms for driving the organic light emitting display of FIG. 8;

FIG. 11 is a circuit diagram of one embodiment of a pixel provided in an organic light emitting display; and

FIG. 12 is an illustration of signal waveforms for driving the organic light emitting display employing the pixel of FIG. 11.

### DETAILED DESCRIPTION OF CERTAIN INVENTIVE EMBODIMENTS

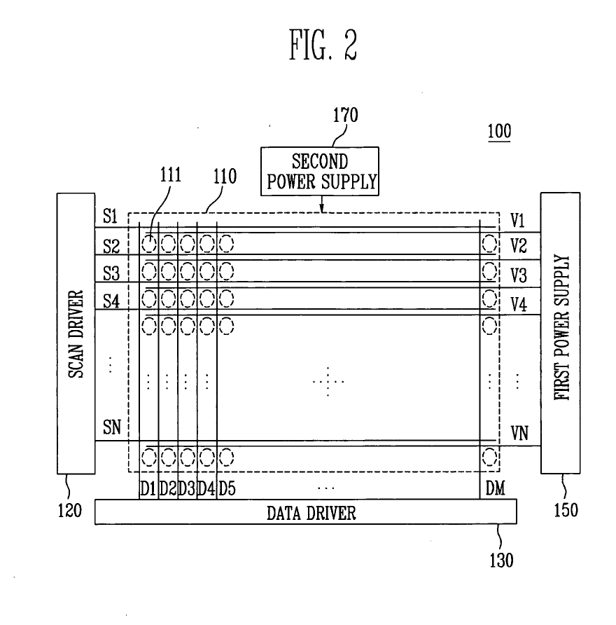

Referring to FIG. 2, the organic light emitting display 100 comprises a pixel portion 110, a scan driver 120, a data driver 130, a first power supply 150, and a second power supply 170.

The pixel portion 110 comprises a plurality of pixels 111 defined by a plurality of scan lines S1 through SN, a plurality of data lines D1 through DM, and a plurality of power source lines V1 through VN. The power source lines V1 through VN are arranged in parallel with the scan lines S1 through SN formed on the pixel portion 110.

An individual pixel 111 is selected when a scan signal is transmitted to the scan line S1 through SN, and the selected pixel 111 emits light based on current received from the power source line V1 through VN corresponding to the data signal transmitted to the data line D1 through DM. More specifically, an organic light emitting diode (OLED) in each pixel 111 emits light based on the current corresponding to bits of the digital data signal, and elements of the pixel 111 control the brightness of the light emission from the OLED. The currents are based on a first power signal having different voltage levels supplied to the power source lines V1 through VN, such that the brightness of an OLED is adjusted to represent gradation (or gray scale). Thereby, the display 100 displays an image with desired gradation.

The scan driver 120 generates a scan signal in response to scan control signals, e.g., a start pulse and a clock signal, which are transmitted from a controller (not shown). The scan driver 120 supplies the scan signals to the scan lines S1 through SN in sequence, thereby sequentially driving the scan lines S1 through SN.

The data driver 130 supplies a digital data signal of i bits to the respective pixels 111 through the data lines D1 through DM in response to a data control signal supplied from the controller. Specifically, the data driver 130 supplies each digital data signal of i bits to the data lines D1 through DM per j sub-frames, where i is a positive integer and j is a positive integer equal to or larger than i. In one embodiment, the sub-frame is set by dividing one frame into at least two sub-frames, and predetermined gradation is represented in each sub-frame. In one embodiment, the least significant bit (LSB) digital data signal among the digital data signals of i bits is supplied in reference to a first sub-frame.

The second power supply 170 is configured to supply a second power, different from the first power, to a cathode electrode of each pixel 111. In one embodiment, the cathode electrode of each pixel 111 is formed on substantially the entire area of the pixel portion 110.

The first power supply 150 is configured to generate first power signals, which are different from each other, for the respective j sub-frames forming one frame. The first power supply 150 is configured to supply driving power to the power source lines V1 through VN in sequence, so that the driving power is synchronized with the scan signal supplied to the scan lines S1 through SN according to each digital data signal. In one embodiment, the driving power increases as a bit position of the digital data signal approaches the most significant bit.

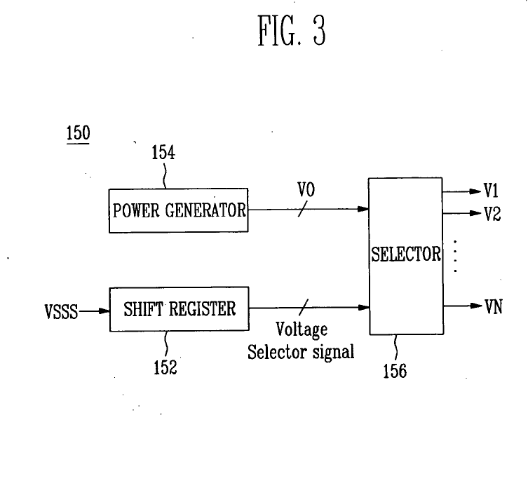

FIG. 3 is a block diagram of one embodiment of the first power supply 150 of the organic light emitting display 100. Referring to FIG. 3, the first power supply 150 comprises a power generator 154, a shift register circuit 152, and a selector 156. The power generator 154 is configured to generate a plurality of first power signals VO, each having a different voltage level, and to supply the first power signals VO to the selector 156.

The shift register circuit 152 comprises a plurality of shift registers. Each shift register is configured to sequentially shift a starting signal VSSS synchronized with the scan signal, thereby supplying the starting signal VSSS to the selector 156. Each shift register is further configured to sequentially shift k bits (where k is a positive integer) and generate a voltage selector signal, and supply the voltage selector signal to the selector 156. Where an eight (8) bit digital data signal and eight sub-frames are provided, each shift register generates a voltage selector signal of three (3) bits and supplies it to the selector 156.

The selector 156 comprises a plurality of voltage selectors. In one embodiment, each voltage selector comprises an analog switch. Each voltage selector is configured to select one of the plurality of different first power signals VO supplied from the power generator 154 in correspondence to the voltage selector signal supplied from each shift register of the shift register circuit 152. The selector 156 is further configured to supply the selected first power signal to the first power source lines V1 through VN in sequence. In one embodiment, the first power signal sequentially supplied from the selector 156 to the first power source lines V1 through VN is synchronized with the scan signal supplied to the scan line S1 through SN.

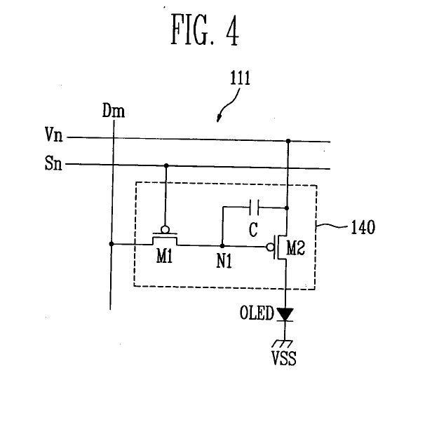

FIG. 4 is a circuit diagram of one embodiment of the pixel 111 in the organic light emitting display 100. Referring to FIG. 4, the pixel 111 comprises an organic light emitting diode OLED, and a pixel circuit 140.

The OLED comprises an anode electrode connected to the pixel circuit 140, and a cathode electrode connected to a second power source line configured to supply second power VSS.

The OLED comprises an emitting layer, an electron transport layer, and a hole transport layer, which are interposed between an anode electrode and a cathode electrode. Additionally, the OLED may comprise an electron injection layer and a hole injection layer. In operation, when voltage is applied between the anode electrode and the cathode electrode, electrons generated from the cathode electrode move to the emitting layer via the electron injection layer and the electron transport layer, and holes generated from the anode electrode move to the emitting layer via the hole injection layer and the hole transport layer. Then, the electrons from the electron transport layer and the holes from the hole transport layer are recombined in the emitting layer, thereby emitting the light.

The pixel circuit 140 comprises a first transistor M1, a second transistor M2, and a capacitor C. In one embodiment, the first and second transistors M1 and M2 are of a p-type metal oxide semiconductor field effect transistor (PMOS FET). Where the pixel circuit 140 is configured with the PMOS FET, the second power source VSS has a voltage level lower than that of the first power. For example, the second power source VSS may have a ground level.

The first transistor M1 comprises a gate electrode connected to the scan line Sn, a source electrode connected to the data line Dm, and a drain electrode connected to a first node N1. The first transistor M1 supplies the data signal from the data line Dm to the first node N1 in response to the scan signal transmitted through the scan line Sn.

The second transistor M2 comprises a gate electrode connected to the first node N1, wherein the drain electrode of the first transistor M1 and a capacitor C are commonly connected to the first node N1. The second transistor M2 further comprises a source electrode connected to the first power source line Vn, and a drain electrode connected to the anode electrode of the OLED. The second transistor M2 adjusts the intensity of current flowing from the first power source line VDD to the OLED on the basis of voltages supplied from the capacitor C to its own gate electrode.

The capacitor C comprises a first electrode connected to the first node N1, which is coupled to the gate electrode of the second transistor M2. The capacitor also comprises a second electrode connected to the first power source line Vn. The capacitor C stores voltage therein corresponding to the digital data signal, which is transmitted to the first node N1 through the first transistor M1 while the scan signal is transmitted to the scan line Sn. The capacitor C maintains the second transistor M2 to be turned on for each sub-frame of one frame while the firs transistor M1 is turned off. In operation, the OLED emits light based on the current supplied from the first power source line Vn through the second transistor M2.

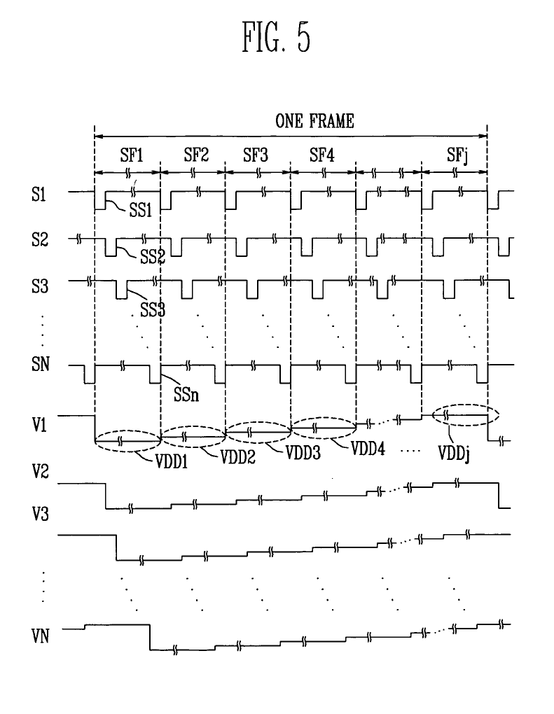

FIG. 5 is an illustration of signal waveforms for driving the organic light emitting display of FIG. 2. Referring to FIG. 5, the organic light emitting display 100 operates by dividing one frame into j sub-frames SF1 through SFj corresponding to the respective bits of the digital data signals of i bits and having the same emission period, in order to represent a desired gradation by controlling the brightness. In one embodiment, the 1^{st} through j^{th} sub-frames SF1 through SFj have gradations corresponding to differently weighted brightness. Here, the gradation rates corresponding to the brightness of the 1^{st} through j^{th} sub-frames SF1 through SFj are 2⁰:2¹:2²:2³:2⁴:2⁵: . . . :2^{j}, respectively.

In one embodiment, the organic light emitting display 100 is operated as follows. First, in the 1^{st} sub-frame SF1 of one frame, low scan signals SS1 through SSn are sequentially transmitted to the scan lines S1 through SN, and at the same time, first power VDD1 having a first voltage level is supplied to the respective first power source lines V1 through VN. In response to the scan signals and first power signals, the first transistors M1 of each pixel 111, connected to the respective scan lines S1 through SN, are turned on in sequence. Thereby, the 1^{st} bit digital data signal is supplied to the gate electrode of each second transistor M2 via the first transistor M1 and the first node N1 in each pixel 111 (see FIG. 4). At this time, each capacitor C stores a voltage corresponding to the difference between the first power signal VDD1 having a first voltage level and the 1^{st} digital data signal at the first node N1.

When high scan signals SS1 through SSN are sequentially supplied to the respective scan lines S1 through Sn, the voltage corresponding to the 1^{st} bit digital data signal stored in each capacitor C is supplied to the gate terminal of each second transistor M2. In response, each second transistor M2 supplies the current corresponding to the 1^{st} bit digital data signal from the first power source line V1 through VN to each OLED on the basis of the first power signal VDD1 having the first level.

In the 1^{st} sub-frame, the OLED receives a current corresponding to the voltage stored in the capacitor C on the basis of the first power signal VDD1 having the first voltage level, as supplied through the first power source lines V1 through VN. The OLED then emits light with a brightness of either “0” or “2⁰” gradations. In one embodiment, the OLED emits light with a brightness corresponding to the “2⁰” gradation when the 1^{st} bit digital data signal is “0”, but does not emit light when the 1^{st} bit digital data signal is “1”.

In the 2^{nd} sub-frame SF2, the low scan signals SS1 through SSn are sequentially transmitted to the scan lines S1 through SN, and at the same time, the second power source VDD2, having the second voltage level higher than the first voltage level VDD1, is supplied to the power source line V1 through VN. In response to the scan signals and second power source signals, the first transistors M1 connected to the respective scan lines S1 through SN are turned on in sequence, so that the 2^{nd} bit digital data signal is supplied to the gate electrode of each second transistor M2 via the first transistor M1 and the first node N1 at each pixel 111. At this time, each capacitor C stores a voltage corresponding to a difference between the second power source VDD2 having the second voltage level and the 2^{nd} digital data signal at the first node N1.

When high scan signals SS1 through SSN are sequentially supplied to the respective scan lines S1 through Sn, the voltage corresponding to the 2^{nd} bit digital data signal stored in each capacitor C is supplied to the gate terminal of each second transistor M2. In response thereto, the second transistor M2 supplies the current corresponding to the 2^{nd} bit digital data signal from the second power source line V1 through VN to the OLED on the basis of the second power signal VDD2.

In the 2^{nd} sub-frame, the OLED receives the current corresponding to the voltage stored in the capacitor C on the basis of the second power VDD2 supplied through the first power source line V1 through VN. In response to the received current, the OLED emits light with a brightness of either “0” or “2¹” gradations. That is, the OLED emits light with a brightness corresponding to the “2¹” gradation when the 2^{nd} bit digital data signal is “0”, but does not emit light when the 2^{nd} bit digital data signal is “1”.

Similarly, in the 3^{rd} sub-frame SF3, the OLED emits light in the same manner as the foregoing descriptions with a brightness corresponding to either “0” or “2²” gradations depending on the received current. The current corresponds to the 3^{rd} bit digital data signal and is based on the third power signal VDD3 having a third voltage level, wherein the third voltage level is higher than the second voltage level of the second power VDD2, and wherein the third power signal VDD3 is supplied through the first power source lines V1 through VN. Thus, the OLED emits light with a brightness corresponding to the “2²” gradation when the 3^{rd} bit digital data signal is “0”, but does not emit light when the 3^{rd} bit digital data signal is “1”.

In the 4^{th} through j^{th} sub-frames SF4 through SFj of one frame, the OLED emits light with brightness corresponding to either “0” or “2³” through “2ⁱ” gradations depending on the current corresponding to the 4^{th} through j^{th} bit digital data signals. The current is based on power signals VDD4 through VDDj having fourth through j^{th} voltage levels, wherein the voltage levels of each of the power signals increase from VDD4 through VDDj.

Thus, in the organic light emitting display 100, the voltage levels of the first power signals VDD1 through VDDj supplied to the anode electrode of the OLED are different according to the respective sub-frames SF1 through SFj. Thereby, desired gradations for a single frame are represented by the sum of brightness for the respective sub-frames SF1 through SFj. Specifically, the different voltage levels of the first power signals VDD1 through VDDj correspond to the respective bits of the digital data signal of i bits, and the digital data signal is supplied to the first power source lines V1 through VN for the respective sub-frames SF1 through SFj, wherein the sub-frames have the same emission period. Thereby, the organic light emitting display 100 displays an image with desired gradation.

Thus, according to the first embodiment of the present invention, the organic light emitting display 100 utilizes power signals with different voltage levels for representing gradation, thereby minimizing non-uniform brightness due to property differences between the transistors in the pixels 111. is minimized. Further, according to the first embodiment of the present invention, Furthermore, the sub-frames SF1 through SFj have equal emission periods are equalized in the emission period, thereby securing enough time for gradation representation based on the different supply voltage levels in each sub-frame

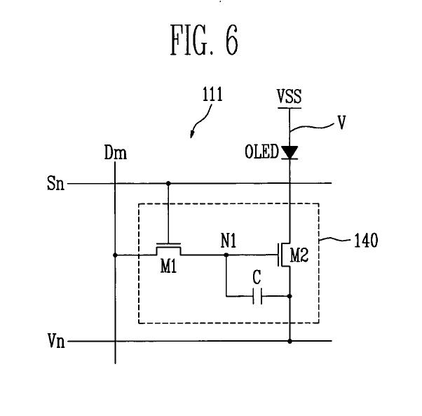

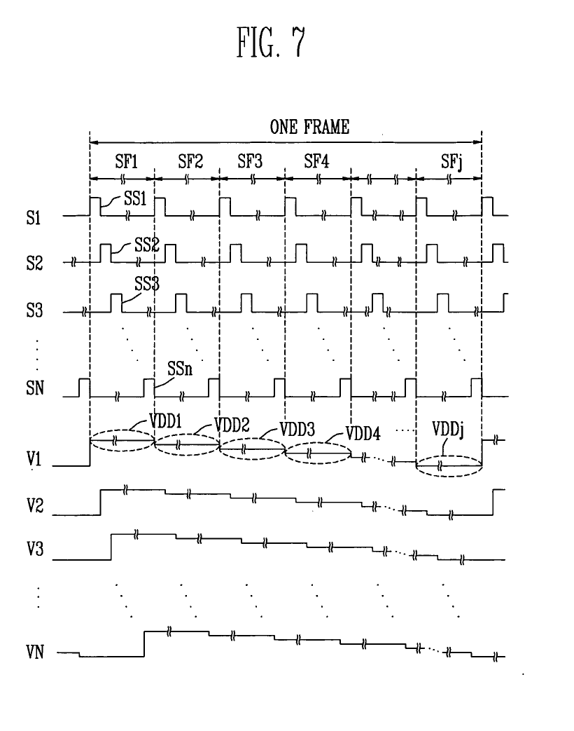

FIG. 6 is a circuit diagram of a second embodiment of a pixel 111 for a second embodiment of an organic light emitting display, and FIG. 7 is an illustration of signal waveforms for driving the organic light emitting display comprising the pixels of the second embodiment. Referring to FIGS. 6 and 7, the pixel 111 has the same configuration as that of the first embodiment, except that transistors M1 and M2 of a pixel circuit 140 are different in an impurity type (N-MOS type) from those of the first embodiment.

According to the second embodiment, the organic light emitting display is operated in substantially the same manner as the first embodiment, except the polarities of the scan signals are different so as to drive N-type transistors M1 and M2. A method of driving the organic light emitting display of the second embodiment is substantially the same as the first embodiment 100, and therefore a discussion thereof is omitted.

In the above-described embodiments of organic light emitting displays, each pixel 111 comprises two transistor M1 and M2 and one capacitor C. However, the pixels 111 are not limited thereto, wherein each pixel may comprise at least two transistors and at least one capacitor.

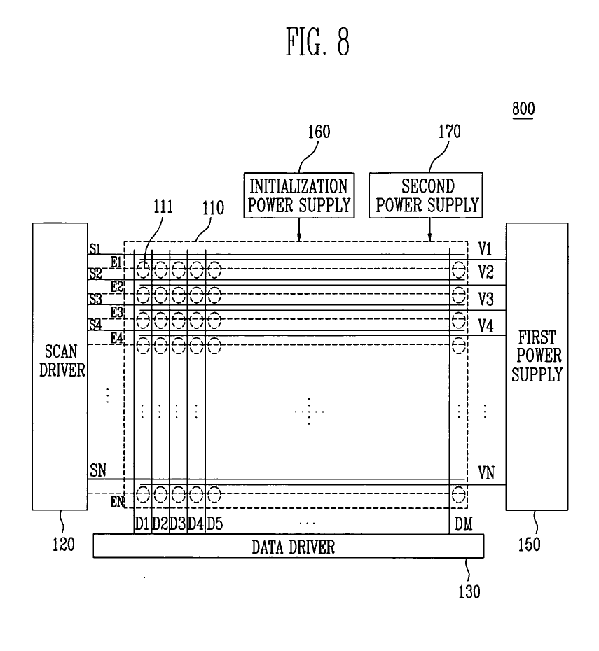

FIG. 8 is an illustration of a third embodiment of an organic light emitting display 800. Referring to FIG. 8, the organic light emitting display 800 comprises a pixel portion 110, a scan driver 120, a data driver 130, a first power supply 150, a second power supply 170, and an initialization power supply 160.

The pixel portion 110 comprises a plurality of pixels 111 defined by a plurality of scan lines S1 through SN, a plurality of data lines D1 through DM, and a plurality of first power source lines V1 through VN. In one embodiment, the first power source lines V1 through VN are arranged in parallel with the scan lines S1 through SN formed on the pixel portion 110.

An individual pixel 111 is selected when a scan signal is transmitted to the scan line S1 through SN, and the selected pixel emits light based on current received from the power source line V1 through VN corresponding to the data signal transmitted to the data line D1 through DM. The pixel 111 comprises an OLED, and the brightness of the OLED is controlled wherein the OLED emits light based on the current corresponding to bits of the digital data signal. The currents are based on first power signals, having different voltage levels, which are supplied to the power source lines V1 through VN, so that brightness of the OLED is adjusted to represent gradation, thereby displaying an image with desired gradation on the display. Furthermore, each pixel 111 emits light on the basis of an emission control signal transmitted to emission control lines E1 through EN.

The scan driver 120 is configured to generate the scan signal in response to scan control signals, e.g., a start pulse and a clock signal, transmitted from a controller (not shown). The scan driver 120 supplies the scan signals to the scan lines S1 through SN in sequence, thereby sequentially driving the scan lines S1 through SN. The scan driver 120 is further configured to generate emission control signals and supply them to the emission control lines E1 through EN in sequence.

The data driver 130 is configured to supply the digital data signal of i bits to the respective pixels 111 through the data lines D1 through DM in response to a data control signal supplied from the controller. Specifically, the data driver 130 supplies each digital data signal of i bits to the data lines D1 through DM per j sub-frames, where i is a positive integer and j is an positive integer equal to or greater than i. In one embodiment, the least significant bit (LSB) digital data signal among the digital data signals is supplied for a first sub-frame.

The second power supply 170 is configured to supply a second power signal to a second power source line of each pixel 111. In one embodiment, the second power source line of each pixel 111 is electrically connected to a cathode electrode of each pixel 111, wherein the cathode electrode is formed on substantially the entire area of the pixel portion 110.

The initialization power supply 160 is configured to supply initialization power to each pixel 111.

The first power supply 150 is configured to generate the first power signals, having different voltage levels, for the respective j sub-frames forming one frame. The first power supply 150 supplies the first power signals to the power source lines V1 through VN in sequence, so that the first power signals are synchronized with the scan signals supplied to the scan lines S1 through SN according to the digital data signals. In one embodiment, the voltage level of the first power signal becomes higher as bit position of the digital data signals approach the most significant bit. The first power supply 150 of the organic light emitting display 800 is substantially the same configuration as the organic light emitting display 100, and therefore a detailed description is omitted.

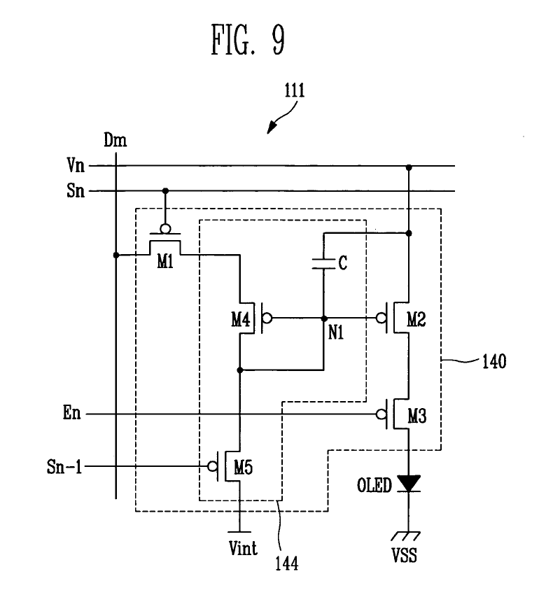

FIG. 9 is a circuit diagram of one embodiment of the pixel 111 provided in the organic light emitting display 800 of FIG. 8. Referring to FIG. 9, the pixel 111 comprises an OLED and a pixel circuit 140. The OLED comprises an anode electrode connected to the pixel circuit 140, and a cathode electrode connected to a second power source line for supplying second power VSS.

The pixel circuit 140 comprises a first transistor M1, a second transistor M2, a third transistor M3, and a compensation circuit 144. The compensation circuit 144 comprises a fourth transistor M4, a fifth transistor M5, and a capacitor C. In one embodiment, the transistors M1, M2, M3, M4 and M5 are p-type metal oxide semiconductor field effect transistors (PMOS FETs). Where the pixel circuit 140 is configured with the PMOS FETs, as illustrated in FIG. 9, the second power signal VSS has a voltage level lower than that of the first power signal VDD. For example, the second power VSS may have a ground level.

The first transistor M1 comprises a gate electrode connected to the scan line Sn, a source electrode connected to the data line Dm, and a drain electrode connected to a source electrode of the third transistor M3. The first transistor M1 supplies the digital data signal from the data line Dm to the source electrode of the fourth transistor M4 of the compensation circuit 144 in response to the first scan signal transmitted through the n^{th} scan line Sn.

The fourth transistor M4 comprises a gate electrode connected to a first node N1, a source electrode connected to the drain electrode of the first transistor M1, and a drain electrode connected to the first node N1 and a drain electrode of the fifth transistor M5. The gate electrode and the drain electrode of the fourth transistor M4 are electrically connected to each other, so that the fourth transistor M4 is connected as a diode between the drain electrode of the first transistor M1 and the source electrode of the fifth transistor M5.

The fifth transistor M5 comprises a gate electrode connected to the (n−1)^{th} scan line Sn−1, a source electrode connected to the drain electrode of the fourth transistor M3 and the first node N1, and the drain electrode connected to an initialization power source line Vint. In operation, the fifth transistor M5 supplies the initialization power from the initialization power source line Vint to the first node N1 in response to the second scan signal transmitted to the (n−1)^{th} scan line Sn−1. Thus, first scan signals are supplied to the current scan line, and second scan signals are supplied to the previous scan line. Thus, the n^{th} pixel is connected to both the current scan line, or n^{th} scan line, and the previous scan line, or the (n−1)^{th} scan line.

The second transistor M2 comprises a gate electrode connected to the first node N1, a source electrode connected to the first power source line Vn, and a drain electrode connected to a source electrode of the third transistor M3. In operation, the second transistor M2 outputs current from the first power source line Vn to the third transistor M3, wherein the current corresponds to voltage applied between the second transistor's gate and source electrodes.

The second and fourth transistors M2 and M4 are thus electrically connected to each other to form a current mirror. Thereby, the same current flows in the second and fourth transistor M2 and M4 with regard to the same digital data signal on the assumption that the second and fourth transistors M2 and M4 have the same channel width.

The capacitor C comprises a first electrode connected to the first node N1, i.e., commonly connected to each gate electrode of the second and fourth transistor M2 and M4, and a second electrode connected to the first power source line Vn. In operation, the capacitor C stores voltage therein corresponding to the initialization power supplied to the first node N1 through the fifth transistor M5 while the second scan signal is transmitted to the (n−1)^{th} scan line Sn−1. The capacitor C turns on the second transistor M2 according to the stored voltage while the first scan signal is supplied to the n^{th} scan line Sn, thereby storing the digital data signal supplied through the first and fourth transistors M1 and M4. The digital data voltage stored in the capacitor C is equal to the difference between the threshold voltage Vth of the fourth transistor M4 and the voltage of the digital data signal.

The capacitor C maintains the second transistor M2 to be turned on for each sub-frame by the stored voltage when the first transistor M1 is turned off. Therefore, the voltage Vgs applied between the gate and source electrodes of the second transistor M2 is equal to the voltage difference between the voltage of the digital data signal and the threshold voltage of the fourth transistor M4, in response to the first power supplied to the first power source line V1 through VN.

The third transistor M3 comprises a gate electrode connected to the emission control line En, the source electrode connected to the drain electrode of the second transistor M2, and a drain electrode connected to the anode electrode of the OLED. In operation, the third transistor M3 supplies the current from the second transistor M2 to the OLED in correspondence to the emission control signal, which is supplied through the emission control line En. Thus, the OLED emits light based on the current supplied from the second transistor M2 through the third transistor M3.

In the organic light emitting display 800 comprising the compensation circuit 144 of FIG. 9, the second and fourth transistors M2 and M4 of the current mirror have similar or equal properties. Thereby, the capacitor C is charged with a voltage corresponding to the digital data signal for each bit and the threshold voltage of the fourth transistor M4, thus ignoring the threshold voltage of the second transistor M2. Thereby, an image is displayed regardless of the threshold voltage of the second transistor M2.

Thus, the OLED coupled to the pixel circuit 140 of FIG. 9, which includes the compensation circuit 144, emits light in response to the current from the first power source line Vn, which is supplied in correspondence to the digital data signal of each bit. As a result, the organic light emitting display 800 can display images having uniform brightness regardless of differences between the threshold voltages of the second transistors M2 employed in the pixels of the display.

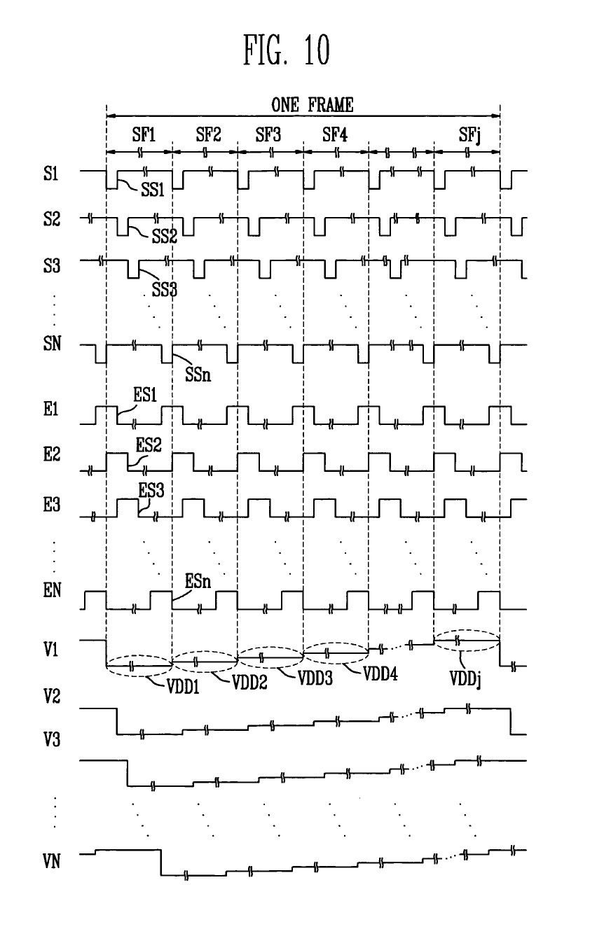

FIG. 10 is an illustration of driving signal waveforms for the organic light emitting display 800. Referring to FIG. 10, the organic light emitting display 800 operates by dividing one frame into j sub-frames SF1 through SFj corresponding to the respective bits of the digital data signals of i bits, wherein each sub-frame has the same emission period. The division of frames into sub-frames prevents non-uniform brightness due to differences in threshold voltages between the second transistor M2 of each pixel 111, and results in representation of a desired gradation by controlling the brightness. The 1^{st} through j^{th} sub-frames SF1 through SFj have gradations corresponding to differently weighted brightness. In one embodiment, the gradation rates corresponding to the brightness of the 1^{st} through j^{th} sub-frames SF1 through SFj are 2⁰:2¹:2²:2³:2⁴:2⁵: . . . :2^{j}, respectively.

As noted above, each pixel is connected to two scan lines: a current scan line and a previous scan line. For example, a pixel in the n^{th} horizontal row is connected to the n^{th} scan line and the (n−1)^{th} scan line. First scan signals are supplied to the current scan lines, and second scan signals are supplied to the previous scan lines. Referring to FIG. 10, the 1^{st} sub-frame SF1 of one frame includes an initialization period wherein low second scan signals SS1 through SSn are sequentially transmitted to the previous scan lines SN through SN−1, so as to turn on the fifth transistor M5 of each pixel 111 through scan line Sn−1. When the fifth transistor M5 is turned on, the initialization power signal is supplied from the initialization power source line Vint to the first node N1 through the fifth transistor M5. This initialization power Vint supplied to the first node N1 has a lower voltage level than the data signal and is stored in the capacitor C. Thereby, the fourth transistor M4 will be turned on when the data signal is transmitted via the first transistor M1. After a lapse of a predetermined period, the low second scan signal SSn through SSn−1 is changed to a high state, so that the fifth transistor M5 is turned off, thereby completing the initialization period.

Meanwhile, the third transistor M3 is turned off by the high emission control signal ES supplied through the emission control line En while the low second and first scan signals SS are supplied to the previous scan lines SN through SN−1 and the current scan lines S1 through SN.

Also in the 1^{st} sub-frame SF1 of one frame, low first scan signals SS1 through SSn−1 are sequentially transmitted to the current scan lines S1 through SN, so as to turn on the first transistor M1 of each pixel 111. At the same time, the first power signal VDD1, having the first voltage level, is supplied to the first power source lines V1 though VN and synchronized with the low first scan signals SS1 through SSn supplied to the current scan lines S1 through SN. Therefore, the 1^{st} bit digital data signal supplied to the data line Dm is supplied to the source electrode of the fourth transistor M4 when the first transistor M1 is turned on. The fourth transistor M4 is turned by the initialization power stored in the capacitor C, and supplies the 1^{st} bit digital data signal from the first transistor M1 to the first node N1. Thus, the capacitor C of each pixel 111 is charged with the voltage corresponding to the 1^{st} bit digital data signal supplied to the first node N1. The voltage stored in the capacitor C is equal to the voltage difference between the 1^{st} bit digital data signal applied to the first node N1 and the threshold voltage Vth of the fourth transistor M4.

Referring to FIG. 10, after a lapse of a predetermined period, the low first scan signal SS1 through SSn is changed to a high state. In response to the high first scan signal, the first and fourth transistors M1 and M4 are turned off, and the second transistor M2 is maintained in an on state by the voltage stored in the capacitor C. Thus, the second transistor M2 of each pixel 111 is driven by the voltage stored in the capacitor C, and the second transistor M2 supplies current to the third transistor M3 in correspondence to the difference between the first power VDD1, having the first voltage level supplied through the first power source line V1 through VN, and the voltage stored in the capacitor C.

When the low first and second scan signals SS respectively supplied to the current scan lines S1 through SN and previous scan lines SN through SN−1 are changed to a high state, the low emission control signal ES is supplied to the emission control line En, thereby turning on the third transistor M3 of each pixel 111, which supplies the current from the second transistor M2 to the OLED.

Thus, in the 1^{st} sub-frame, the OLED receives the current from the second and third transistors M2 and M3 in correspondence to the 1^{st} bit digital data signal, wherein the current is based on the first power VDD1 having the first voltage level supplied through the first power source line V1 through VN. In response to the current, the OLED emits light with brightness of either “0” or “2⁰” gradations. In one embodiment, the OLED emits light with brightness corresponding to the “2⁰” gradation when the 1^{st} bit digital data signal is “0”, but does not emit light when the 1^{st} bit digital data signal is “1”.

Similarly, in the 2^{nd} sub-frame SF2, the OLED emits light in the same manner as the 1^{st} sub-frame SF1 with a brightness corresponding either “0” or “2” gradations. The brightness of the emitted light depends on the current corresponding to the 2^{nd} bit digital data signal, wherein the current is based on the first power signal VDD2 having a second voltage level, higher than the first power VDD1 having the first voltage level, that is supplied through the first power source line V1 through VN.

Likewise, in the 3^{rd} through j^{th} sub-frames SF3 through SFj of one frame, the OLED emits light a brightness corresponding to either “0” or “2²” through “2¹” gradations depending on the current corresponding to the 3^{rd} through j^{th} bit digital data signals. The current is based on the power signals VDD3 through VDDj having third through j^{th} voltage levels, wherein the voltage levels increase between each power signal.

Thus, in the organic light emitting display 800, the compensation circuit 144 is configured to compensate for the threshold voltage Vth of the second transistor M2. In addition, the first power signals VDD1 through VDDj supplied to the anode electrode of the OLED have different voltage levels according to the respective sub-frames SF1 through SFj, such that desired gradations are represented by the sum of brightness for the respective sub-frames SF1 through SFj. Accordingly, non-uniform brightness due to property differences between the transistors is minimized in the display 800. Furthermore, the sub-frames SF1 through SFj have equal emission periods, thereby securing enough time for gradation representation.

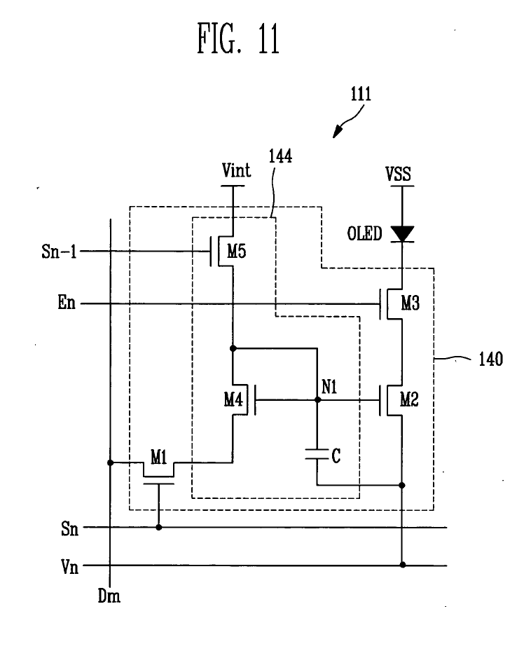

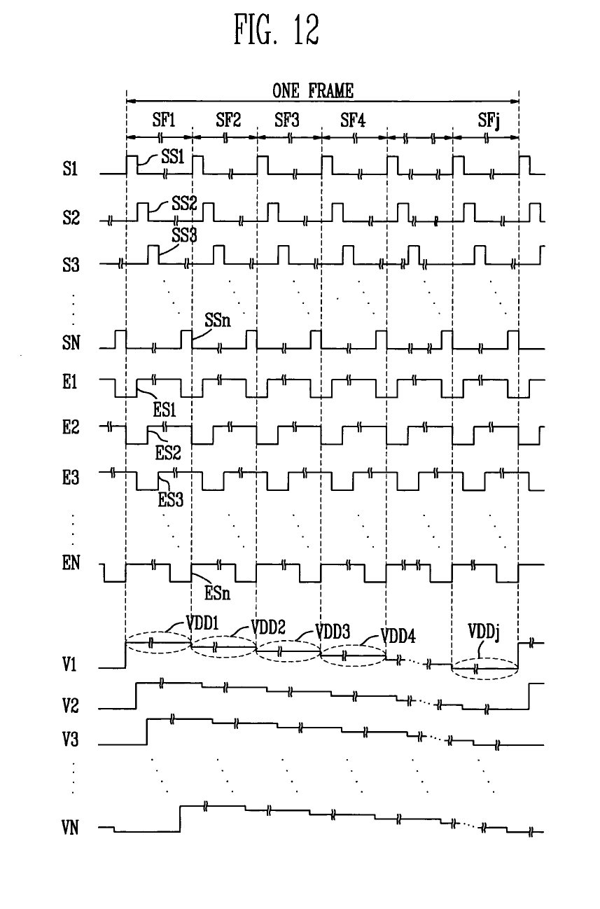

FIG. 11 is a circuit diagram of a fourth embodiment of a pixel 111 provided in an organic light emitting display, and FIG. 12 is an illustration of signal waveforms for driving the organic light emitting display provided with the fourth embodiment of the pixel 111. Referring to FIGS. 11 and 12, the pixel 111 has a configuration similar to that of the third embodiment, except that the transistors M1 through M5 of the pixel circuit 140 are NMOS transistors. Accordingly, the pixel circuit 140 is coupled to the OLED with a polarity opposite to the connection of the pixel circuit illustrated in FIG. 9. Similarly, the driving signals as illustrated in FIG. 12 are similar to the driving signals of FIG. 10, except the signals have opposite polarities in order to drive the NMOS transistors. Thus, the organic light emitting display employing the pixel of FIG. 11 is operated in a manner similar to that described in reference to the organic light emitting display 800, and therefore a discussion thereof is omitted.

In the organic light emitting display embodiments described above, the sub-frames have the same emission period. However, the invention is not limited to such a configuration, and the respective sub-frames may have different emission periods to improve gradation representation and picture quality.

In addition, the pixel, organic light emitting display comprising the same, and the driving methods thereof may be implemented in any display apparatus capable of displaying an image by controlling current.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An organic light emitting display comprising a plurality of pixels defined by a plurality of scan lines configured to supply a scan signal, a plurality of data lines configured to supply a data signal, and a plurality of power source lines configured to supply a power signal, each pixel comprising:
a pixel circuit configured to output a current corresponding to the data signal, wherein the current is output from the power source line which supplies power per each sub-frame of a plurality of sub-frames associated with a frame of display data; and
an organic light emitting diode configured to emit light based on the output current from the pixel circuit.

2. The organic light emitting display according to claim 1, wherein each pixel represents gradation depending on a brightness sum of light emitted from the organic light emitting diode in each sub-frame.

3. The organic light emitting display according to claim 1, wherein the data signal comprises a digital data signal having i bits corresponding to each sub-frame, where i is a positive integer.

4. The organic light emitting display according to claim 3, wherein a voltage level of the power signal increases as the bit position of the digital data signal approaches a most significant bit.

5. The organic light emitting display according to claim 3, wherein supply of the power signal is synchronized with the transmission of the scan signal to the scan line.

6. The organic light emitting display according to claim 1, wherein the power source lines are arranged in parallel with the scan lines.

7. The organic light emitting display according to claim 1, wherein the pixel circuit comprises:
a first transistor controlled by the scan signal and configured to output the data signal;
a second transistor configured to supply current from the power source line to the organic light emitting diode in correspondence to a voltage applied between a gate and a source of the second transistor; and
a capacitor configured to store the data signal output from the first transistor, and control the voltage applied between the gate and the source of the second transistor on the basis of the stored data signal.

8. An organic light emitting display comprising:
a pixel portion comprising a plurality of pixels defined by a plurality of scan lines, a plurality of data lines, and a plurality of first power source lines, wherein each first power source line is connected to a row of the pixels, wherein each pixel is configured to emit light in response to a current received from its respective first power source line, wherein the current corresponds to a data signal transmitted through the data line and is supplied from the first power source line;
a data driver configured to supply the data signals to the data lines;
a scan driver configured to supply a plurality of scan signals to the scan lines; and
a first power supply configured to supply first power signals to the first power source lines in correspondence to each of a plurality of sub-frames associated with a frame of display data.

9. The organic light emitting display according to claim 8, wherein each pixel represents gradation on the basis of a brightness sum of light emitted in each sub-frame.

10. The organic light emitting display according to claim 8, wherein the data signal comprises a digital data signal having i bits corresponding to each sub-frame in a frame, where i is a positive integer.

11. The organic light emitting display according to claim 10, wherein the voltage levels of the first power signals increase as the bit position of the digital data signal approaches a most significant bit.

12. The organic light emitting display according to claim 8, wherein the first power signal is synchronized with the scan signal.

13. The organic light emitting display according to claim 8, wherein the first power source lines are arranged in parallel with the scan lines.

14. The organic light emitting display according to claim 8, wherein the first power supply comprises:
a power generator configured to generate power signals having different voltage levels;
a shift register circuit configured to generate a voltage selector signal corresponding to each sub-frame; and
a selector circuit configured to select one of the power signals having different voltage levels in correspondence to the voltage selector signal, and further configured to supply the selected power signal to at least one of the first power source lines.

15. The organic light emitting display according to claim 8, further comprising a second power supply configured to generate second power signals different from the first power signals, and further configured to supply the second power signals to a second power source line connected to each pixel.

16. The organic light emitting display according to claim 15, wherein each pixel comprises:
a pixel circuit configured to output current from the first power source line in correspondence to the data signal; and
an organic light emitting diode coupled between the pixel circuit and the second power source line and configured to emit light based on the output current from the pixel circuit.

17. The organic light emitting display according to claim 1, wherein the pixel circuit comprises:
a first transistor controlled by the scan signal, wherein the first transistor is configured to output the data signal;
a second transistor configured to supply the current from the power source line to the organic light emitting diode corresponding to the voltage applied between a gate and a source of the second transistor; and
a capacitor configured to store the data signal outputted from the first transistor, wherein the capacitor is further configured to control the voltage applied between the gate and the source of the second transistor based on the stored data signal.

18. A method of driving an organic light emitting display comprising a plurality of pixels, wherein the pixels are defined by a plurality of scan lines, a plurality of data lines, and a plurality of power source lines, the method comprising:
supplying a scan signal to the scan line;
supplying a data signal to the data line;
supplying power to the power source line in correspondence to each of a plurality of sub-frames associated with a frame of display data; and
supplying current to a pixel such that the pixel emits light, wherein the current is based on the supplied power and is supplied to the pixel in correspondence to the data signal.

19. The method according to claim 18, wherein each pixel comprises an organic light emitting diode, and wherein each pixel represents gradation on the basis of a brightness sum of light emitted from the organic light emitting diode in each sub-frame.

20. The method according to claim 19, wherein the data signal comprises a digital data signal having i bits corresponding to each sub-frame, where i is a positive integer.

21. The method according to claim 20, wherein a voltage level of the supplied power increases as the bit position of the digital data signal approaches a most significant bit.

22. The method according to claim 18, wherein the supply of the power to the power source line is synchronized with the transmission of the scan signal to the scan line.

23. An organic light emitting display comprising a plurality of pixels defined by a plurality of scan lines through which a scan signal is supplied, a plurality of data lines through which a data signal is supplied, and a plurality of power source lines through which a power signal is supplied, each pixel comprising:
a pixel circuit comprising a first transistor configured to output current from the power source line corresponding to the data signal, wherein the power is supplied corresponding to each of a plurality of sub-frames associated with a frame of display data, and wherein the pixel circuit further comprises a compensation circuit configured to compensate for a threshold voltage of the transistor; and
an organic light emitting diode configured to emit light based on the output current from the pixel circuit.

24. The organic light emitting display according to claim 23, further comprising:
an emission control line configured to supply an emission control signal to the pixel circuit; and
an initialization power source line configured to supply initialization power to the pixel circuit.

25. The organic light emitting display according to claim 24, wherein the pixel circuit comprises:
a second transistor controlled by a first scan signal transmitted through a first scan line, wherein the second transistor is configured to output the data signal to the compensation circuit, and wherein the first transistor is further configured to output current corresponding to a voltage output from the compensation circuit; and
a third transistor controlled by the emission control signal and configured to supply the current from the first transistor to the organic light emitting diode.

26. The organic light emitting display according to claim 25, wherein the compensation circuit comprises:
a fourth transistor coupled to the second transistor in a current mirror configuration, wherein the fourth transistor is configured to output the data signal from the second transistor to the first transistor;
a fifth transistor controlled by a second scan signal supplied through a second scan line, wherein the fifth transistor is configured to supply the initialization power to a first node, wherein the first node is connected to the gate electrodes of the first and third transistors; and
a capacitor connected between the first node and the power source line.

27. The organic light emitting display according to claim 23, wherein each pixel represents gradation on the basis of a brightness sum of light emitted from the organic light emitting diode in each sub-frame.

28. The organic light emitting display according to claim 27, wherein the data signal comprises a digital data signal having i bits corresponding to each sub-frame, where i is a positive integer.

29. The organic light emitting display according to claim 28, wherein a voltage level of the power signal increases as the bit position of the digital data signal approaches a most significant bit.

30. The organic light emitting display according to claim 23, wherein the power signal is synchronized with the scan signal.

31. The organic light emitting display according to claim 23, wherein the power source lines are arranged in parallel with the scan lines.

32. An organic light emitting display, comprising:
a pixel portion, comprising a plurality of pixels defined by a plurality of scan lines, a plurality of data lines, and a plurality of power source lines, wherein each pixel is configured to emit light in response to a current form the power source line, wherein the current is supplied to the pixel in correspondence to a data signal transmitted through the data line;
a data driver configured to supply the data signal to the data line;
a scan driver configured to supply the scan signal to the scan line;
a power supply configured to supply a power signal to the first power source line in correspondence to each of a plurality of sub-frames associated with a frame of display data; and
an initialization power supply configured to supply initialization power to each pixel.

33. The organic light emitting display according to claim 32, wherein each pixel represents gradation on the basis of a brightness sum of light emitted in every sub-frame.

34. The organic light emitting display according to claim 33, wherein the data signal comprises a digital data signal having i bits corresponding to each sub-frame, where i is a positive integer.

35. The organic light emitting display according to claim 34, wherein a voltage level of the first power signal increases as the bit position of the digital data signal approaches a most significant bit.

36. The organic light emitting display according to claim 34, wherein the first power signal is synchronized with the scan signal.

37. The organic light emitting display according to claim 32, wherein the power supply comprises:
a power generator configured to generate power signals having different voltage levels;
a shift register circuit configured to generate a voltage selector signal corresponding to each sub-frame; and
a selector circuit configured to select one of the power signals having different voltage levels corresponding to the voltage selector signal, wherein the selector circuit is further configured to supply the selected power signal to the power source line.

38. The organic light emitting display according to claim 32, further comprising:
an emission control line configured to supply an emission control signal to the pixel circuit; and
an initialization power source line configured to supply an initialization power to the pixel circuit.

39. The organic light emitting display according to claim 38, wherein each pixel comprises:
a pixel circuit comprising a transistor configured to output current corresponding to the data signal, wherein the output current is based on power supplied through the power source line according to each sub-frame, and wherein the pixel circuit further comprises a compensation circuit configured to compensate for a threshold voltage of the transistor; and
an organic light emitting diode configured to emit light based on the output current from the pixel circuit.

40. The organic light emitting display according to claim 39, wherein the pixel circuit comprises:
a first transistor controlled by a first scan signal transmitted through a first scan line, wherein the first transistor is configured to output the data signal, transmitted through the data line, to the compensation circuit;
a second transistor configured to supply the current through the power source line in correspondence to a voltage outputted from the compensation circuit; and
a third transistor, controlled by the emission control signal supplied through the emission control line, and configured to supply the current from the second transistor to the organic light emitting diode.

41. The organic light emitting display according to claim 40, wherein the compensation circuit comprises:
a fourth transistor coupled to the second transistor in a current mirror configuration, wherein the fourth transistor is configured to output the data signal from the first transistor to the second transistor;
a fifth transistor, controlled by a second scan signal supplied through a second scan line, and configured to supply the initialization power to a first node coupled to gate electrodes of the second and third transistors; and
a capacitor connected between the first node and the power source line.

42. The organic light emitting display according to claim 32, wherein the power source lines are arranged in parallel with the scan lines.

43. A method of driving a plurality of pixels that are defined by a plurality of scan lines, a plurality of data lines, and a plurality of power source lines, wherein each pixel comprises a transistor configured to output current corresponding to a data signal supplied through one of the data lines, the method comprising:
charging a capacitor with voltage corresponding to a threshold voltage of the transistor on the basis of initialization power, wherein the capacitor is charged in correspondence to a first scan signal transmitted through a first scan line;
supplying the data signal to the data line;
supplying power to the power source line in correspondence to a sub-frame of one frame;
charging the capacitor with voltage corresponding to a difference between the data signal and the power, wherein the capacitor is charged in correspondence to a second scan signal supplied through a second scan line; and
driving the transistor using the voltage stored in the capacitor and outputting the current from the power supplied to the power source line, thereby allowing an organic light emitting diode to emit light.

44. The method according to claim 43, wherein each pixel represents gradation on the basis of a brightness sum of light emitted in each sub-frame.

45. The method according to claim 44, wherein the data signal comprises a digital data signal having i bits corresponding to each sub-frame, where i is a positive integer.

46. The method according to claim 45, wherein a voltage level of the first power increases as the bit position of the digital data signal approaches a most significant bit.

47. The method according to claim 43, wherein the supply of the first power to the first power source line is synchronized with the scan signal.

48. The method according to claim 43, wherein the data signal is supplied to the capacitor via a mirror transistor coupled to the transistor in a current mirror configuration, and wherein the data signal is supplied in correspondence to the second scan signal.

49. The method according to claim 43, further comprising:
supplying the current from the transistor to the organic light emitting diode according to an emission control signal.

50. A method of driving an organic light emitting display comprising a plurality of pixels, the method comprising:
supplying a scan signal to at least one of the pixels;
supplying a data signal to at least one of the pixels;
supplying power to at least one of the pixels in correspondence to each of a plurality of sub-frames associated with a frame of display data; and
supplying current to an organic light emitting diode such that the organic light emitting diode emits light, wherein the current is supplied to the organic light emitting diode in correspondence to the data signal, and wherein the current is based on the supplied power.
